(19) United States
(12) Patent Application Publication
(10) Pub. No.: US 2008/0283557 A1
(43) Pub. Date: Nov. 20, 2008

(54) SPOUT FOR FOOD STUFF CONTAINER

(76) Inventor: Julianne Desautels, Glenview, IL (US)

Correspondence Address: STANDLEY LAW GROUP LLP, 495 METRO PLACE SOUTH, SUITE 210, DUBLIN, OH, 43017, US

(21) Appl. No.: 11/749,973

(22) Filed: May 17, 2007

(51) Int. Cl. B67D 3/00

(52) U.S. Cl. 222/535; 29/428

(57) ABSTRACT

A spout 10 for application to a generally rectangular container 50 creating a means by which the contents of the container can be easily dispensed, as well as kept fresh and free from contamination via the spout's closing mechanism 40 by which an air-tight seal is achieved. The closing mechanism 40 of the spout is easily engaged by physically manipulating the spouting member 30 from the opened to closed position. The spout 10 can be applied to a container either by the consumer or by the container manufacturer.

### CROSS-REFERENCE TO RELATED APPLICATIONS

This application claims no benefit of priority.

### TECHNICAL FIELD

The embodiments disclosed herein relate to a device that provides more convenient and secure access to the contents of various types of household containers. More particularly, the device is a sealable spout that can be easily implanted into a container making removal of the container's contents easy while ensuring the container's integrity is not compromised.

### BACKGROUND ART

Anyone who starts their day with a bowl of cereal knows of the variety of problems the disclosed invention is designed to address. The containers, to which American consumers have become accustomed and often used to house cereal and similar food stuffs, leave much to be desired. In particular, there are the problems with opening the existing boxes, which includes fumbling with heavy cardboard, hoping that the sealing mechanism—a heavy cardboard tab that slides into a pre-cut narrow slit in a mating lid flap—does not rip off in the process, as well as trying to avoid injury that sometimes occurs when the container has been unevenly torn and a jagged edge is left eagerly awaiting the unsuspecting hand or digit. Additionally, one faces the problems of how to keep the contents of a container whose top has just been dismantled, fresh and free from contamination and how to pour the contents from the disfigured container into a bowl or other container.

What is needed to breathe life back into common household containers is an easy to use device that can be used in conjunction with existing containers, as a means of eliminating the aforementioned problems. The embodiments disclosed herein provide for a sealable spout that can be integrated into common household containers either by the consumer or manufacturer. The spout enables the easy opening, sealing, and pouring of compatible containers.

The existing art has attempted to address the prevalent problems of common household containers, but has provided inadequate solutions. Large plastic containers intended to function as substitutes for disposable containers proved to be awkward and difficult to clean. Plastic liners used within the containers as a way of maintaining the freshness of the contents after the containers had been opened was an idea with much potential but has not implemented in a manner which maximizes its effectiveness. Additionally, the existing art provides for a variety of containers with spout-type openings but fails to provide for a spout that can be easily open and closed with a secure seal and that can also be integrated into a container by either the consumer or manufacturer.

### SUMMARY OF THE INVENTION

This and other unmet advantages of the prior art are provided by the present invention useful for sealing and dispensing the contents of a container. In brief, the disclosed embodiment comprises a spout for application to a generally rectangular container creating a means by which the contents of the container can be easily dispensed, as well as kept fresh and free from contamination via the spout's closing mechanism by which an air-tight seal is achieved. The closing mechanism of the spout is easily engaged by physically manipulating the spouting member from the opened to closed position. The spout can be applied to a container either by the consumer or by the container manufacturer.

The invention disclosed herein has wide application including, but not limited to, creating a more efficient container for food stuffs by providing a spout that is easily incorporated into a container thus allowing for easy dispensation and maintenance of the container's contents.

Further features of the invention will be described or will become apparent in the course of the following detailed description.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings wherein identical characters refer to identical parts and in which:

FIG. 1 is perspective view of the invention installed on a container.

FIG. 2 is a close-up perspective view of the invention showing the spout in the closed configuration.

FIG. 3 is a close-up perspective view of the invention showing the spout in the open configuration.

FIG. 4 is a side elevation view of the invention showing the spout in the closed position.

FIG. 5 is a side elevation detailed sectional view of the invention showing the spout in the closed position.

FIG. 6 is a side elevation detailed sectional view of the invention showing the spout in the open position.

FIG. 7 is a top view of the invention showing the spout in the open position.

FIG. 8 is a top view of the invention showing the spout in the closed position.

### DETAILED DESCRIPTION OF A PREFERRED EMBODIMENT

One exemplary embodiment of the present invention is a spout for application to a generally rectangular container. Another exemplary embodiment of the present invention is a method for incorporating a spout into a generally rectangular container. The generally rectangular container may be a cardboard box that is manufactured for the purpose of holding cereal or other foodstuffs or any other container that is compatible with said spout.

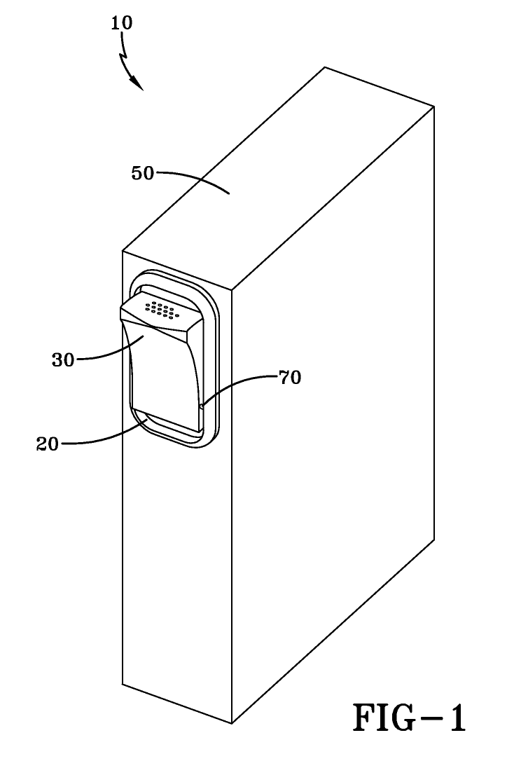

Referring to FIGS. 1 through 3, the invention 10 is mainly comprised of a mounting means 20, a spouting member 30, and a closing mechanism 40. In this device, the mounting means 20 is capable of being incorporated into a generally rectangular container 50. In some embodiments of the present invention the generally rectangular container 50 will have an opening in one of its sides for receiving the mounting means 20. In other embodiments of the present invention where the generally rectangular container 50 does not have an opening for the reception of the mounting means 20, the mounting means 20 may be capable of creating an opening in the container that is the right size to enable the incorporation of the mounting means 20.

The mounting means 20 may be any device which is capable of connecting the spouting member 30 to the generally rectangular container 50. As shown in the embodiment illustrated in FIG. 1, the mounting means 20 may be generally rectangular in shape. In some embodiments the mounting means 20 will be generally circular in shape. In other embodiments of the present invention the mounting means 20 may be of any shape that allows for its incorporation into the generally rectangular container 50 while not inhibiting the functionality of the spouting member 30.

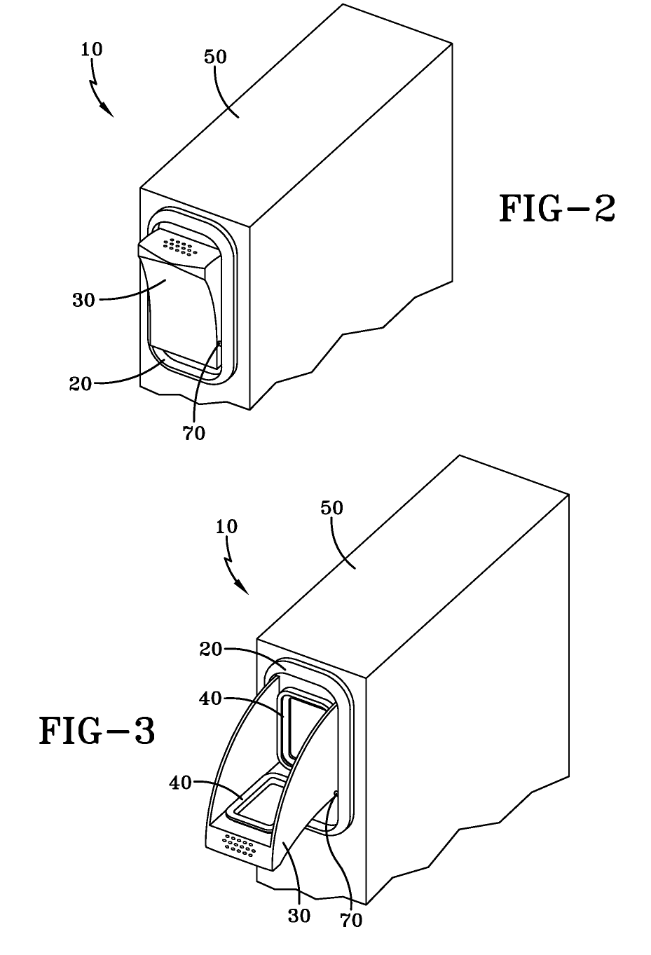

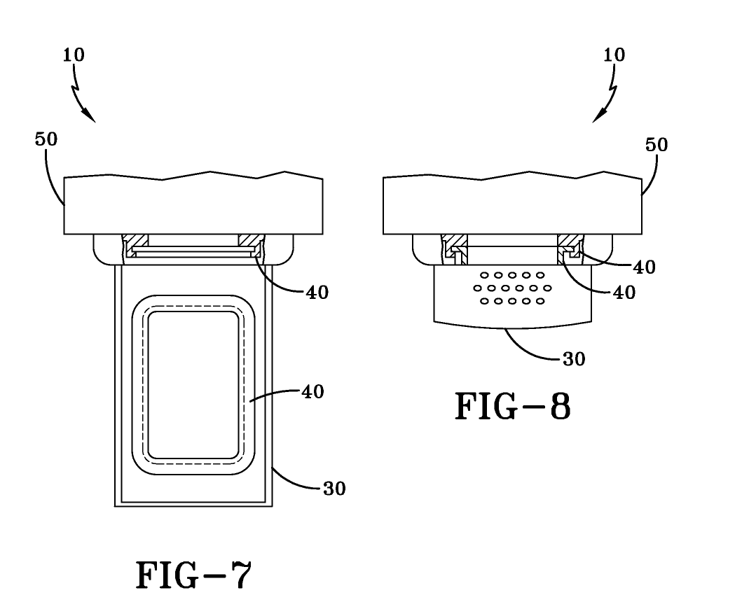

As illustrated in FIGS. 1 and 2, the mounting means 20 is connected to a spouting member 30. The spouting member 30 is connected to the mounting means 20 in such a manner that the spouting member 30 can be opened and closed through the application of physical force. In some embodiments, the connection of the spouting member 30 and the mounting means 20 is accomplished through a hinge 70 located at the terminal end of the spouting member 30. In other embodiments, the spouting member 30 is secured to the mounting means 20 in a manner which allows for the spouting member 30 to be opened and closed through rotation of the spouting member 30 in a circular direction. In another embodiment, the spouting member 30 is actually a limb of the mounting means 20 that is capable of opening and closing. The device includes a closing mechanism 40 shown in FIG. 3 that enables the spouting member 30 to stay in the closed position when the generally rectangular container 50 is not in use. In some embodiments as is further illustrated in FIGS. 7 and 8, the closing mechanism 40 embodies a snap-fit type sealing interface between the mounting means 20 and the spouting member 30 when the spouting member 20 is in the closed position. In other embodiments, the closing mechanism 40 is a latch or similar structure that can be positioned over the spouting member to keep it closed. It should be noted that the invention 10 may advantageously be comprised of a material that lends itself to simple and low-cost manufacture, such as an injection-moldable polymer. Furthermore, the mounting means 20 may be configured of a firm yet malleable metal that can be manually adjusted to grasp the edges of an opening within the top, bottom, front, back, or one of said side walls of the generally rectangular container 50 to form the tight fit between said mounting means 20 and said generally rectangular container 50.

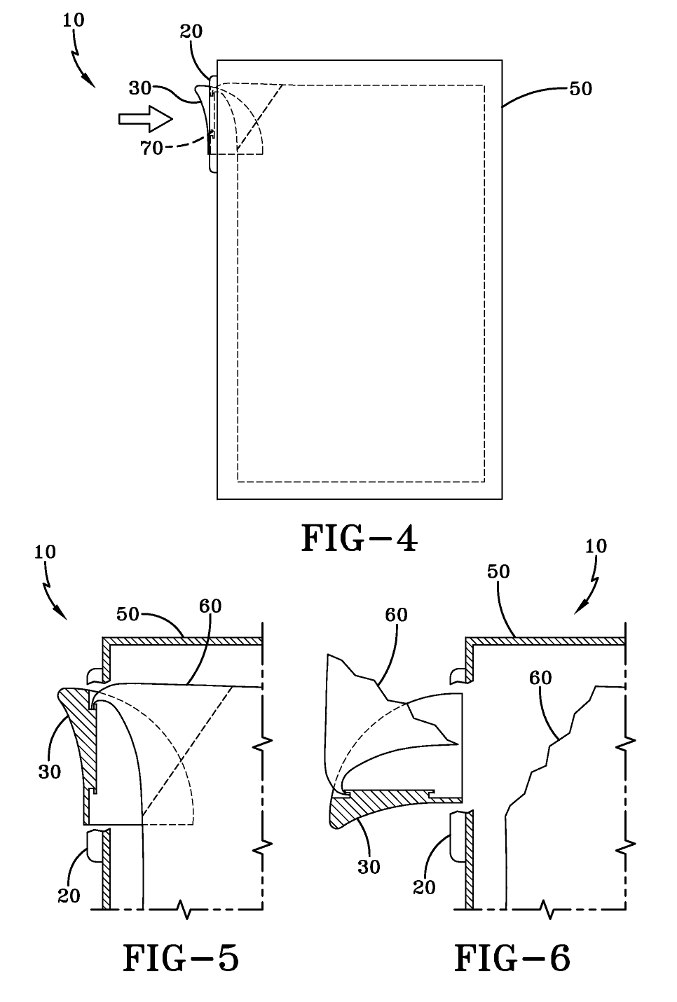

In a preferred embodiment, the device of the present invention is incorporated into a generally rectangular container 50 that has been manufactured to hold cereal or a similar foodstuff. The mounting means 20 and the generally rectangular container 50 form a tight fit that prevents the device from shifting within the generally rectangular container 50 when the container is moved and similarly prevents the device from falling out of the generally rectangular container 50. Referring to FIGS. 4 through 6, the spouting member 30 is initially in the closed position and has been configured so that when it is moved to be in the open position it causes a plastic liner 60 within the generally rectangular container 50 to become unsealed. The plastic liner 60 may be a plastic bag of the type currently sold within cereal boxes as a means of keeping the cereal fresh or may be any plastic liner capable of forming an air tight seal. The plastic liner 60 may be contained within the generally rectangular container 50 or it may be adhered to the inside of the generally rectangular container 50 such that the inner surface of the generally rectangular container 50 forms the outer surface of the plastic liner 60 in its entirety.

In a preferred embodiment of the system of the present invention 10, and as shown by the arrow in FIG. 4, a force is applied to the surface of the invention 10 that causes the mounting means 20 to penetrate one of the sides of a generally rectangular container 50. Once the mounting means 20 has penetrated the generally rectangular container 50 a portion of the generally rectangular container 50 is removed creating an opening within the generally rectangular container 50 that is enclosed by the mounting means 20. The portion of the mounting means 20 that penetrated the generally rectangular container 50 is molded around the edges of the generally rectangular container 50 that are left exposed by the opening that now exists therein.

In some embodiments the mounting means 20 may be only a fraction of the size of the side of the generally rectangular container 50 in which it is incorporated while in other embodiments the mounting means 20 may form one of the sides of the generally rectangular container 50 in its entirety. The size of the spouting member 30 will vary depending on the size of the generally rectangular container 50, the size of the mounting means 20, and the intended use of said container.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A spout for application to a generally rectangular container having a top, bottom, front, back, and two side walls, comprising:
a mounting means for positioning said spout onto the top, bottom, front, back, or one of said side walls of the generally rectangular container, said mounting means being capable of integration with the top, bottom, front, back, or one of said side walls of the generally rectangular container creating a tight seal;
said mounting means having an opening for a spout and a hinged spouting member mounted therein and movable between an open and closed position;
said spouting member being capable of forming a tight seal with said mounting means when positioned in the closed position; and
a closing mechanism for selectively maintaining the spouting member in the closed position.

2. The spout of claim 1 wherein:
said spouting member is attached to a generally rectangular container having a top, bottom, front, back, and two side walls,
said generally rectangular container contains a sealed lining device,
said sealed lining device is attached to the spouting member so that the movement of the spouting member from the closed to opened position causes the sealed lining device to be unsealed.

3. The spout of claim 1 wherein:
said spouting member is made of a polymeric material.

4. The spout of claim 1 wherein:
said spouting member forms an air-tight seal with said mounting means when in the closed position.

5. The spout of claim 1 wherein:
said mounting means includes a mechanism for creating an opening in a generally rectangular container having a top, bottom, front, back, and two side walls;
said opening being of the size needed to allow for a tight fit between said mounting means and said generally rectangular container.

6. The spout of claim 1 wherein:
said spout forms the top, bottom, front, back, or one of said side walls of the generally rectangular container in its entirety.

7. The spout of claim 1 wherein:
said mounting means is configured of a firm yet malleable metal that can be manually adjusted to grasp the edges of an opening within the top, bottom, front, back, or one of said side walls of the generally rectangular container to form the tight fit between said mounting means and said generally rectangular container.

8. The spout of claim 1 wherein:
said spouting member forms an air-tight seal with said mounting means when in the closed position.

9. A spout for application to a generally rectangular container having a top, bottom, front, back, and two side walls, comprising:
a mounting means for positioning said spout onto the top, bottom, front, back, or one of said side walls of the generally rectangular container, said mounting means being capable of integration with the top, bottom, front, back, or one of said side walls of the generally rectangular container creating a tight seal;
said mounting means being attached to a spouting member;
said spouting member being capable of rotation in such a manner that rotation in one direction causes an opening between said spouting member and said mounting means while rotation in the counter clockwise opposite direction causes an opening between said spouting member and said mounting means to be closed; and
a closing mechanism for selectively maintaining the spouting member in the closed position.

10. The spout of claim 9 wherein:
said spouting member is attached to a generally rectangular container having a top, bottom, front, back, and two side walls,
said generally rectangular container contains a sealed lining device, said sealed lining device is attached to the spouting member so that the movement of the spouting member from the closed to opened position causes the sealed lining device to be unsealed.

11. The spout of claim 9 wherein:
said spouting member is made of a polymeric material.

12. The spout of claim 9 wherein:
said spouting member forms an air-tight seal with said mounting means when in the closed position.

13. The spout of claim 9 wherein:
said mounting means includes a mechanism for creating an opening in a generally rectangular container having a top, bottom, front, back, and two side walls;
said opening being of the size needed to allow for a tight fit between said mounting means and said generally rectangular container.

14. The spout of claim 9 wherein:
said mounting means is configured of a firm yet malleable metal that can be manually adjusted to grasp the edges of an opening within the top, bottom, front, back, or one of said side walls of the generally rectangular container to form the tight fit between said mounting means and said generally rectangular container.

15. The spout of claim 9 wherein:
said spouting member forms an air-tight seal with said mounting means when in the closed position.

16. A method for incorporating a spout into a generally rectangular container, comprising:
Penetrating one of the sides of a generally rectangular container with the edges of a mounting means that is connected to a spouting member;
Removing a portion of the generally rectangular container, said portion of the generally rectangular container being of the same size as an opening within the mounting means that is provided for the functionality of the spouting member;
Physically molding the portion of the mounting means which penetrated said generally rectangular container around the edges of the opening therein forming a tight fit between the mounting means and the generally rectangular container.
